(19) United States
(12) Patent Application Publication
(10) Pub. No.: US 2021/0039981 A1
(43) Pub. Date: Feb. 11, 2021

(54) PLATE-SHAPED GLASS ARTICLES AND METHODS OF PRODUCING AND USING

(71) Applicant: SCHOTT AG, Mainz (DE)

(72) Inventors: Jochen Alkemper, Klein-Winternheim (DE); Rüdiger Dietrich, Jena (DE); Jovana Djordjevic-Reiss, Mainz (DE); Inge Burger, Oestrich-Winkel (DE)

(73) Assignee: SCHOTT AG, Mainz (DE)

(21) Appl. No.: 16/986,191

(22) Filed: Aug. 5, 2020

(30) Foreign Application Priority Data
Aug. 5, 2019 (DE) 10 2019 121 144.1

(51) Int. Cl. C03C 3/083; C03C 21/00

(52) U.S. Cl. CPC C03C 3/083; C03C 21/002

(57) ABSTRACT

A plate-shaped or disc-shaped, chemically prestressed or chemically prestressable glass article is provided. The article includes a glass with a composition of SiO₂, Al₂O₃, and Li₂O; and a set-drop strength of at least 50 and up to 150, given as drop height in cm, wherein the drop height is given as the mean value of 15 samples, with the use of a sandpaper grit of 60. The glass has one or more features including: a CIL of greater than 1 N, 1.2 N, 2N, or 3 N, a DoL of at least 90 μm, 100 μm, 115 μm, or 130 μm, a content of network formers of at least 82 wt. %, and a content of alkali oxides of at most 14 wt. % or 12 wt. %.

### CROSS REFERENCE TO RELATED APPLICATIONS

This application claims benefit under 35 USC § 119 of German Application No. 10 2019 121 144.1 filed Aug. 5, 2019, the entire contents of which are incorporated herein by reference.

### BACKGROUND

### 1. Field of the Invention

The invention generally refers to plate-shaped or disc-shaped glass articles, in particular chemically prestressed or at least chemically prestressable glass articles, the production thereof, as well as the use thereof. In addition, the invention also refers to a glass composition.

### 2. Description of Related Art

Chemically prestressable glasses and/or chemically prestressable or chemically prestressed glass articles and/or methods for producing such articles are generally known.

In some cases, chemically prestressable glasses can differ with respect to so-called aluminum silicate glasses (also referred to as AS glasses, alumosilicate glasses or aluminosilicate glasses), which comprise as components Al₂O₃ and SiO₂ in particular, as well as alkali oxides except for lithium oxide Li₂O, as well as lithium-aluminum silicate glasses (also called LAS glasses, lithium alumosilicate glasses or lithium aluminosilicate glasses), which additionally comprise Li₂O as a component.

Usually, chemically prestressed glass articles should have a DoL (Depth of compressive stress Layer, also referred to as a compressive stress zone or compressive stress depth) as large as possible. This is advantageous, since, in this way, cracks will be prevented from further propagation due to the compressive stress in this compressive stress zone. The larger the DoL is, the deeper the crack can penetrate into the volume of the glass article without bringing about a further spontaneous crack propagation.

Compressive-stressed glass articles in this case are constructed so that in the compressive stress zones, which are usually formed on both main surfaces of a plate-shaped or disc-shaped glass article wherein preferably, these compressive stress zones are designed to be very similar and symmetric as much as possible or approximately symmetric on both main surfaces of the plate-shaped glass article, in particular relative to a mirror plane running through the center of the glass article and parallel to the main surfaces of the glass article, a central tensile stress zone connecting them. As soon as the crack is sufficiently long so that it reaches through a compressive stress zone into the tensile stress zone, thus when the crack is longer than the thickness of the compressive stress zone, this leads to the breaking of the glass article.

For reinforcement, for example of so-called protective glasses (also called a cover or cover glass) for mobile devices, glass compositions that make possible a deep ion exchange are therefore selected. For example, so-called LAS glasses are used, which make possible a deep ion exchange of lithium ions (from the glass) for sodium ions (from the exchange bath).

Alternatively or additionally, one can attempt to reduce the stress intensity of the crack. Of course, glasses are generally brittle materials having a high stress intensity at the tip of the crack. It has also been shown that LAS glasses that are accessible for a very deep ion exchange, as stated above, have a very great brittleness, which leads to a very high stress intensity at the crack tip. This is a disadvantage.

The stress intensity at the crack tip is not directly measurable. Of course, it correlates with the CIL, the “crack initiation load”. The “crack initiation load” describes the load under which, when a Vickers indenter is impressed in the center, two radial cracks arise in the material, proceeding from the corners of the impression. The higher this value is, the fewer cracks will form in the glass.

In general, cracks can arise due to processing and/or handling, for example in the production of a glass article. Also, during use of a glass article, for example, when it is used as a protective glass for a mobile device, such as a tablet computer or a smartphone, cracks can occur.

Frequently, in addition to glasses, other transparent materials, for example, crystalline materials such as Al₂O₃ (corundum, which, however also is used often as a cover panel, called sapphire or sapphire glass) or transparent plastics are also used as a cover. The above-given relationships relative to crack propagation and “CIL” are also correspondingly valid for these materials.

With respect to the formation of cracks, for example, the impact on a hard, rough substrate is critical. Here, in particular, the brittleness of the material of a so-called “cover” becomes crucial, i.e., how strong is the material of the cover, e.g., the glass and/or the glass article vis-a-vis the formation and the propagation of cracks initiated by the impact.

Since prestressed glass is present in applications as a “cover”, on the one hand, the property of the glass matrix itself is thereby crucial. On the other hand, however, the stress introduced by an ion exchange in the resulting prestressed glass article also plays a role.

Known LAS glasses, which have been optimized with respect to ion exchange, thus making possible a particularly great depth of exchange, have rather small CIL values, which for the most part lie below 1 N at a relative air humidity of 40%. The CIL of a brittle material, especially a glass, is determined by repeated uniform impression of a Vickers indenter in a surface of the brittle material under stable, regulated ambient humidity. In this case, ambient humidity means the relative air humidity in the environment of the test specimen, thus here the sample of a brittle material such as, for example, a glass article. In the prior art, usually CIL values are given in which the determination of the CIL has been made in a dry environment, for example in a nitrogen atmosphere.

Thus, it has not been possible previously to counteract in an optimized manner the propagation of cracks introduced in chemically prestressed glass articles, in particular in chemically prestressed glass articles comprising a so-called LAS glass. Even when a very great depth of exchange is achieved, a breaking of the glass or glass article can still occur, namely in deep cracks, independently of the precise value of the prestressing achieved. In other words, glasses or glass articles that comprise such glasses having a very high depth of exchange very rapidly show breakage failure in the case of impact on a rough surface having relatively large, pointed particles. On the other hand, many glasses that have a high CIL and only a small thickness of the compressive stress zone fail even in the case of contact with smaller, pointed particles, since the cracks penetrate very rapidly into the region of the glass article that is under tensile stress. Involved here, in particular, are those glasses that have a poor exchange capacity. In particular, boron-containing aluminosilicate glasses do not make it possible to achieve great exchange depths.

Therefore, there is a need for glasses and/or glass articles with optimized strength properties, in particular for glass articles or glasses that are chemically prestressed or chemically prestressable and have or enable a high strength in the case of impact on pointed objects. In addition, there is a need for manufacturing methods for such glass articles or glasses.

### SUMMARY

The object of the invention in a first aspect is to provide glass articles, preferably chemically prestressed or chemically prestressable glass articles that at least mitigate the weaknesses of the prior art. Further aspects relate to the production of such glass articles, their use, as well as a glass composition of a chemically prestressable glass.

The invention therefore relates to plate-shaped or disc-shaped, chemically prestressed or chemically prestressable glass articles comprising a glass with a composition comprising SiO₂, Al₂O₃ and Li₂O, having at least one of the following features: a CIL of greater than 1 N, preferably greater than 1.2 N, particularly preferred greater than 2, and most particularly preferred greater than 3 N, wherein the CIL is preferably determined in the non-prestressed state; and/or a DoL of at least 90 μm, preferably at least 100 μm, for thicknesses of the glass article of at least 0.4 mm up to at most 0.55 mm; and/or of at least 100 μm, preferably of at least 115 μm, for thicknesses of the glass article of more than 0.55 mm up to at most 0.7 mm; and/or of at least 115 μm, preferably at least 130 μm, for thicknesses of more than 0.7 mm up to at most 1 mm; and of at least 130 μm for thicknesses of the glass article of more than 1 mm and preferably up to 3 mm thickness, preferably at most 2 mm thickness; and/or a content of network formers of at least 82 wt. % and/or a content of alkali oxides of at most 14 wt. %, preferably at most 12 wt. %, so that preferably the prestressed glass article has a set-drop strength of at least 50 and preferably up to 150, given as drop height in cm, wherein the drop height is given as the mean value of 15 samples, with the use of a sandpaper grit of 60. Such a configuration of a chemically prestressable or chemically prestressed glass article has a number of advantages.

Due to the configuration of the glass article in that it comprises a glass with a composition comprising SiO₂, Al₂O₃ and Li₂O, the glass article is formed in a way that a high exchange depth is possible for sodium. This is because the glass article comprises a LAS glass or is itself formed from LAS glass.

In the presently disclosed embodiments, the glass article has a maximum CIL of at most 5 N, preferably at most 6 N, more preferably at most 7.5 N with the method for producing it that is currently disclosed in the present document.

The glass article has at least one of the following features: a CIL of greater than 1 N, preferably greater than 1.2 N, particularly preferred 2 N, and most particularly preferred greater than 3 N, wherein the CIL is preferably determined in the non-prestressed state.

This is advantageous, since with such a design, the basic glass is already a glass which offers a certain resistance to a crack propagation.

### BRIEF DESCRIPTION OF THE DRAWINGS

FIG. 1 is a schematic and not-true-to-scale representation of a plate-shaped glass article according to present disclosure;

FIG. 2 shows a schematic and not-true-to-scale sectional representation of the glass article of FIG. 1;

FIG. 3 shows an overall view of the set-drop test apparatus with labeling of the individual components;

FIG. 4a shows the sample mount of the set-drop test apparatus of FIG. 3;

FIG. 4b shows the release mechanism of the set-drop test apparatus FIG. 3;

FIG. 5 shows the aluminum housing as the sample mount and the plastic plate as the sample dummy; and

FIG. 6 shows the alignment of the sample dummy in the sample mount using a 2D water balance.

### DETAILED DESCRIPTION

It has been shown that the determination of the CIL on a glass article that is present already prestressed supplies a value different from the determination of the CIL on a non-prestressed glass article, i.e., it is usually an essentially higher value. This is based on the fact that a compressive stress zone is produced by an ion exchange on the surface of the glass article, this zone opposing the propagation of cracks and thus the breaking of the glass. Glass breaking appears only if specific load limits are exceeded, whereby, however, these limits are higher, of course, due to the prestressing than in the non-prestressed glass article. It has been shown, however, that the determination of the CIL on a non-prestressed glass article also already supplies valuable indications of the properties of the glass as such for opposing a crack propagation. With values of the CIL of more than 1 N in the non-prestressed state, a glass or a glass article is already present that has advantageous mechanical properties. However, the CIL is preferably greater than 1.2, particularly preferred greater than 2 N, and most particularly preferred, in fact, greater than 3 N.

The CIL is determined here according to the following measurement specification.

In principle, the CIL of a glass article is determined by the repeated uniform impressing of a Vickers indenter into a glass surface. Here, a glass surface of a float glass is used.

First, the glass article to be tested is stored for at least 24 hours in the test atmosphere (40% relative air humidity, uncontrolled room temperature in the laboratory). Subsequently, the impressions are introduced by means of a Vickers indenter in the test atmosphere, thus at 40% relative air humidity in the environment of the sample. The indenting force is increased in steps. For each force step, at least 10 impressions are carried out. After introducing 10 impressions and a stabilizing time of 15 minutes in the test atmosphere, the number of radial cracks arising at the corners of the Vickers impression per force step is documented for each impression.

The force is increased sufficiently long until 4 radial cracks reliably form at the corners of the Vickers impression for each impression process. Mean value and standard deviation of the number of radial cracks formed for all impressions involved are calculated for each force step. The upper number (subscript “0”, mean value+variance (SD)), the lower number (subscript “u”, mean value-variance (SD)) and average number (mean value) of cracks per impression force are compiled in each case as a data set. A Boltzmann curve is fitted for all three data sets for:

y [symbol] Min

according to:

$$y = \frac{{A}_{1} - {A}_{2}}{1 + {e}^{\frac{x - {x}_{0}}{d x}}} + {A}_{2}$$

with:

A₂=4 and A₁=0

resulting in the inflection point of the curves for a number of 2 cracks:

CIL=x0±((x0−xo)+(xu−x0))/2.

Care should be taken here that, unlike in the prior art, the determination of the CIL is produced presently for 40% relative air humidity. Thus, this is particularly relevant, since the contacting of a glass with humidity, i.e., with water, has a determining influence on strength. At the tip of a crack, this humidity in fact leads to a glass corrosion, which leads to dissolution of bonds in the glass network. Therefore, the CIL for a glass is lower, the higher the relative air humidity is.

Alternatively or additionally, the glass article is formed such that in the prestressed state, it has a DoL of at least 90 μm, preferably at least 100 μm for thicknesses of the glass article of at least 0.4 mm up to at most 0.55 mm; and/or of at least 100 μm, preferably of at least 115 μm for thicknesses of the glass article of more than 0.55 mm up to at most 0.7 mm; and/or of at least 115 μm, preferably at least 130 μm, for thicknesses of more than 0.7 mm up to at most 1 mm; and of at least 130 μm for thicknesses of the glass article of more than 1 mm and preferably up to 3 mm thickness, preferably at most 2 mm thickness.

This is advantageous, since in this way, a load even involving larger particles still cannot penetrate into the region of the glass article that is under tensile stress.

Alternatively or additionally, the glass article is formed such that it has a network former content of at least 82 wt. % and/or a content of alkali oxides of at most 14 wt. %, preferably at most 12 wt,%.

A network former content of the glass or of the glass article of at least 82 wt. % can be advantageous, since in this way, a glass network is obtained that is formed as rigid, i.e., brittle, so that it involves a glass network that is able to store compressive stresses that have been introduced.

Simultaneously or alternatively, it may be advantageous if the content of alkali oxides in the glass and/or in the glass article is limited to at most 14 wt. %, preferably at most 12 wt. %. It has been shown that the prestressability of the glass surprisingly can be negatively influenced by too high a percentage of alkali oxides. This is surprising, since previously it was assumed that a high percentage of alkalis is necessary, since the chemical prestressing is produced by the exchange of alkalis. It is presumed that a high content of alkali oxides, however, leads to the circumstance that the network overall becomes less rigid. A glass network is thus more rigid, the fewer the non-bridging oxygens it has. However, non-bridging oxygens are produced by the addition of alkali oxides to the network formers, in particular in a SiO₂ glass network. Therefore, a limited content of alkali oxides that preferably should not exceed 14 wt. %, preferably 12 wt. %, is advantageous.

Such a glass article can be prestressed, so that preferably the prestressed glass article has a set-drop strength of at least 50 and preferably up to 150, given as drop height in cm, wherein the drop height is given as the mean value of 15 samples, with the use of a sandpaper grit of 60.

The so-called set-drop test is a very important test for mobile devices. This test involves an investigation in which loads of glass articles as they may occur in actual applications are investigated. For this, a glass article is installed as it would be installed, for example, in a more recent mobile device, such as a smartphone. Thus, a model of a device, for example the model of a smartphone is constructed, in which the glass article will be used, for example, as a display covering. The weight of the model in this case corresponds largely to that of an actual device, and likewise the installation of the glass article, but without the use of corresponding components. Then, with the glass article on the bottom, the model is allowed to fall onto a surface, which comprises particles, for example with small radii of curvature. Such tests shall thus simulate real stresses, for example, if a smartphone falls onto asphalt or concrete. In this case, it is generally known that rough ground, thus ground from which sharp stones or grains of sand project is very critical for the integrity of a protective glass for mobile devices. For example, drop heights with the described glass-equipped dummy clearly differ if the fall is onto smooth surfaces—such as granite—or onto rough surfaces with adhering sandpaper, such as granite with adhering sandpaper. Drop heights with rough ground, simulated by granite with adhering sandpaper, are lower than drop heights onto smooth ground.

The set-drop test in this case is preferably conducted as follows:

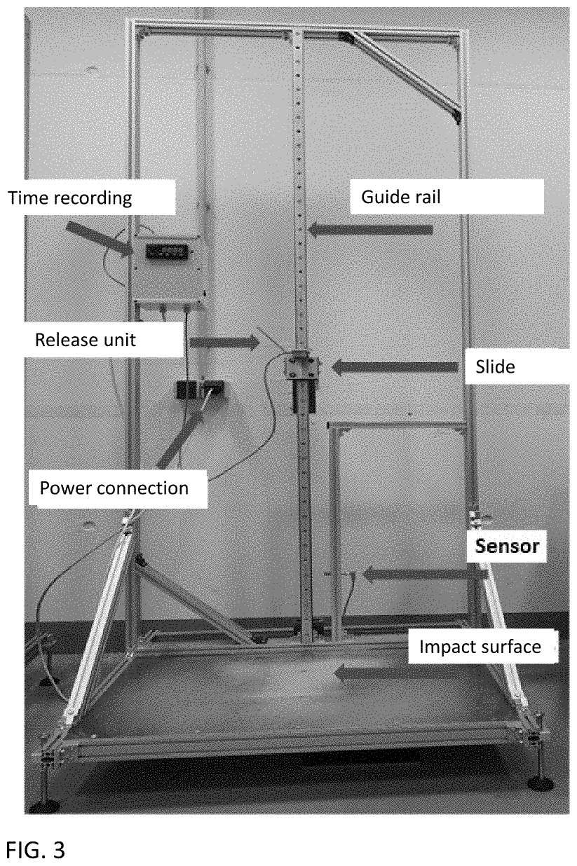

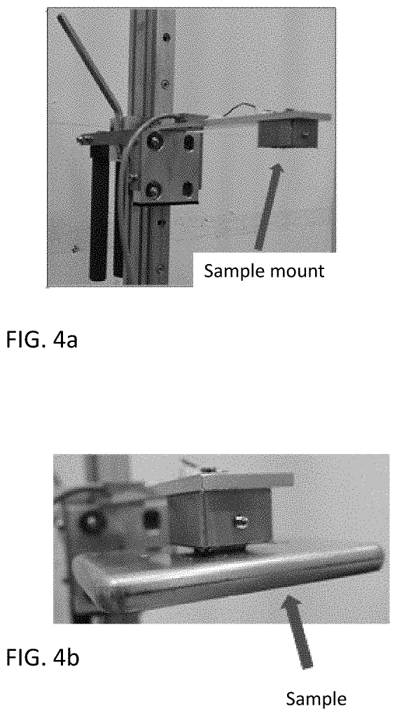

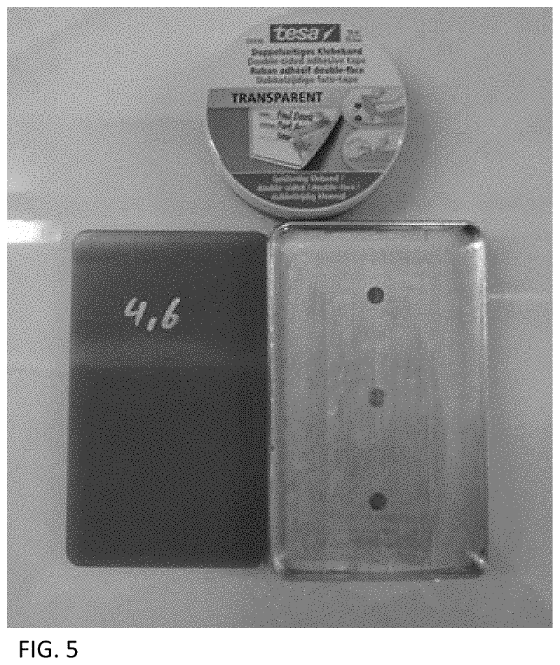

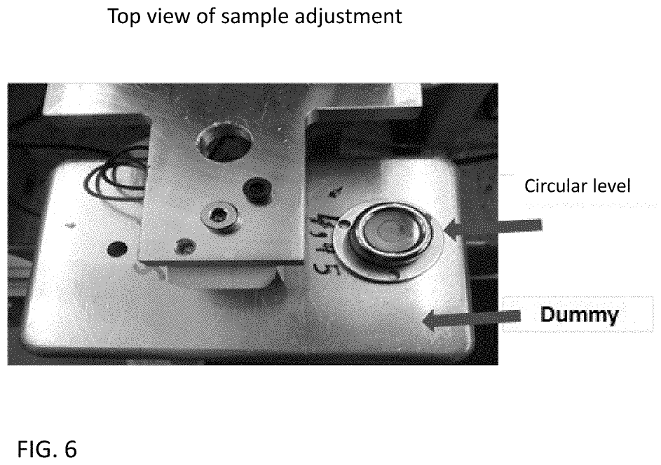

A glass plate is fixed on a sample mount and allowed to fall from cumulative drop heights onto a defined substrate. An overview of the entire structure is shown in FIG. 3. The glass article used in the set-drop test has a length of 99 mm and a width of 59 mm and is shown in FIG. 4, with a sample dummy magnetically attached to the sample mount. In this case, first a plastic plate is adhered by means of double-sided adhesive tape in a metal housing, which has the shape and weight of a holder for a mobile device, for example a smartphone. For example, plastic plates with thicknesses between 4.35 mm and 4.6 mm (see FIG. 5) are suitable in this case. The bonding is preferably produced by means of a double-sided adhesive tape with a thickness of approximately 100 μm. Then the plate-shaped glass article to be tested is adhered by means of double-sided adhesive tape, preferably double-sided adhesive tape with a thickness of 295 μm, in particular a double-sided adhesive tape of the Tesa® trademark, Product Number 05338, so that a distance between 350 μm and 450 μm is obtained between the upper edge of the housing or the mount and the upper edge of the glass article. The glass article lies higher than the frame of the housing and no direct contact should occur between glass body and aluminum housing. The thus-obtained “set’ with a weight of 177.5 g, which recreates the incorporation of a glass article in a mobile device and is a type of “dummy” for an actual mobile device, in particular a smartphone here, is subsequently allowed to fall onto a surface of size DIN A4, the so-called impact surface with the glass side downward at an initial speed of zero in the vertical direction, i.e., the direction of fall. The impact surface in this case is produced as follows: Sandpaper with a corresponding grit, for example, grit 60 (#60) is adhered to a bottom plate by means of a double-sided adhesive tape, for example with an adhesive tape of 100 μm thickness. Tesa (10 m/15 mm), transparent, double-sided tape, Product Number 05338 was used as the adhesive tape. Within the scope of the present disclosure, the grit is defined according to the Standards of the Federation of European Producers of Abrasives (FEPA); for examples, see also DIN ISO 6344, in particular DIN ISO 6344-2:2000-04, Schleifmittel auf Unterlagen—Korngrößenanalyse—Teil 2: Bestimmung der Korngrößenverteilung der Makrokörnungen [Abrasives on substrates—Particle size analysis—Part 2: Determination of the particle size distribution of macroparticles], P 12 to P 220 (ISO 6344-2:1998). The bottom plate must be secure and is preferably made of aluminum or alternatively also of steel. The weight of the bottom plate that is an aluminum substrate in the presently disclosed information is approximately 3 kg. The sandpaper must be completely provided with adhesive tape and be adhered free of bubbles. The impact surface should only be used for ten drop tests and should be exchanged after the tenth drop test. The sample, thus the set obtained, is inserted in the test device and is aligned by means of a 2D-water balance (circular level) so that the set is mounted horizontally, wherein the plate-shaped glass article points toward the bottom, thus in the direction of the impact surface (see FIG. 6). The first drop height is 25 cm, and after this, the drop is from a height of 30 cm. As long as a break has not yet occurred, the drop height is now increased in 10-cm steps until the glass breaks. The break height, the break origin, as well as the break pattern are noted. The test is conducted on 15 samples, and a mean value is calculated.

It may be advantageous to fasten the plate-shaped glass article to the plastic plate so that the plate-shaped glass article remains adhered to a sheet in the case of glass breakage, on the one hand, so that it can be removed as much as possible without problem, but, on the other hand, also to make possible an investigation of the glass article. For this purpose, it can be recommended additionally to arrange a self-adhering sheet to the adhesive tapes used, for example a sheet such as is used for wrapping books, arranging it between the plastic plate and the plate-shaped glass article. The broken plate-shaped glass article can then be removed by means of this sheet.

The following definitions apply in the scope of the present disclosure:

An exchange bath is understood to be a salt melt, wherein this salt melt is used in an ion exchange method for a glass or a glass article. In the scope of the present disclosure, the terms: exchange bath and ion exchange bath are used synonymously.

Usually, salts are used in technical-grade purity for exchange baths. This means that despite the use of only sodium nitrate, for example, as the initial substance for an exchange bath, certain impurities are also comprised in the exchange bath. In this case, the exchange bath is a melt of a salt, for example, of sodium nitrate, or of a mixture of salts, for example, a mixture of a sodium salt and a potassium salt. In this case, the composition of the exchange bath is indicated in such a way that it refers to the nominal composition of the exchange bath without consideration of possibly present impurities. Therefore, insofar as a 100% sodium nitrate melt is stated in the scope of the present disclosure, this means that only sodium nitrate was used as the raw material. The actual content of the exchange bath of sodium nitrate may, however, deviate therefrom and this is also usual, since technical-grade raw materials in particular have a certain percentage of impurities. These are, however, usually less than 5 wt. %, referred to the total weight of the exchange bath, in particular less than 1 wt. %.

In a corresponding manner, for exchange baths that have a mixture of different salts, the nominal contents of these salts are indicated without consideration of impurities of the initial substances due to the technical grade. An exchange bath with 90 wt. % KNO₃ and 10 wt. % NaNO₃ thus may also have some small impurities that are caused, however, by the raw materials, and usually should be less than 5%, referred to the total weight of the exchange bath, in particular, less than 1 wt. %.

In addition, the composition of the exchange bath also changes in the course of the ion exchange, in particular, since lithium ions migrate from the glass or the glass article into the exchange bath due to the continued ion exchange. Such a change in the composition of the exchange bath due to aging is also present, of course, but is not considered as long as it is not otherwise explicitly stated. Rather, in the scope of the present disclosure, for indicating the composition of an exchange bath, the nominal original composition is put down.

In the scope of the present disclosure, a stress profile is understood as the application of mechanical stress in a glass article, such as a glass plate, for example, versus the thickness of the glass article considered, given in a diagram. In the scope of the present disclosure, insofar as a compressive stress profile is indicated, this is understood here as that portion of a stress profile, in which the stress assumes positive values, i.e., is greater than zero. Tensile stress, in contrast, has a negative sign.

In the scope of the present disclosure, a composite compressive stress profile is understood to be a compressive stress profile in which the compressive stress produced in the corresponding article, such as a glass article is composed of at least two sub-regions.

The compressive stress stored in a prestressed glass article results as an integration of the compressive stress over the thickness of the glass article. In the scope of the present disclosure, this integral is referred to as the compressive stress integral.

The tensile stress stored in a prestressed glass article results as an integration of the tensile stress over the thickness of the glass article. In the scope of the present disclosure, this integral is referred to as the tensile stress integral. In the scope of the present disclosure, the terms: stored tensile stress and tensile stress integral can also thus be used synonymously.

In the scope of the present disclosure, a plate-shaped or disc-shaped glass article is understood to be a glass article in which the lateral dimension is smaller in one spatial dimension, at least an order of magnitude smaller, than in the other two spatial directions, whereby these spatial directions are specified relative to a Cartesian coordinate system, in which these spatial directions each time run perpendicular to one another, and in this case, the thickness in the normal direction to the largest or main surface is measured from one main surface to the other main surface.

Since the thickness is at least one order of magnitude smaller than the width and length of the glass article, the width and length in this case can lie on the same order of magnitude. It is, however, also possible that the length is still clearly greater than the width of the glass article. Plate-shaped glass articles in the sense of the present disclosure can therefore also comprise a glass ribbon or strip.

In the sense of the present disclosure, a glass is understood to be a material and a glass article is understood to be a product produced from the glass material and/or comprising the glass material. In particular, a glass article can be composed of glass or predominantly composed of glass; thus the glass material can contain up to at least 90 wt. % glass.

In the scope of the present disclosure, a chemical prestressing is understood as a process in which a glass article is immersed in a so-called exchange bath. In this case, there occurs the exchange of ions. In the sense of the present disclosure, potassium exchange is understood in that potassium ions migrate from the exchange bath into the glass article, in particular into the surface of the glass article, thus, for example, are incorporated therein, whereby simultaneously small alkali ions, such as sodium, for example, migrate from the glass article into the exchange bath. Sodium exchange is understood in a corresponding way, in that sodium ions migrate from the exchange bath into the surface of the glass article, while in contrast, small ions, for example lithium ions migrate from the glass article, in particular from the surface of the glass article, into the exchange bath. As already described above, due to this ion exchange, a compressive stress zone is built up in the surface region of the glass article.

In the scope of the present document, maximum tensile stress is the value of the tensile stress in the center of the glass article, thus at a depth of half the thickness of the glass article.

The tensile stress is usually provided with a negative sign; in contrast, compressive stresses are given a positive sign, since compression and tension have correspondingly opposite directions. In the scope of the present disclosure, insofar as the value of a tensile stress is indicated without a sign being named, it is understood that this case involves the magnitude of the stress. The definition involves here the sign of the stress, as it is usually used by the person skilled in the art, the developer of prestressed protective glasses with respect to the sign of the stress. This directly deviates from the usual designation of compressive stress as negative and tensile stress as positive, as it is usually used in physics, for example. In the scope of the present disclosure, here, of course, as explained, the definition of stresses reverts back to how they are usually used in the glass industry.

Usually in the case of highly prestressable glasses (only these are considered, for example, as protective glasses for mobile devices with high requirements for various strength claims), high values for compressive stress (between 700 MPa and 1000 MPa) are obtained for compressive stress depths between 40 μm and 200 μm. If an exchange occurs not only of one ion, but a combined exchange, for example of potassium ions and sodium ions, as this is usually the case for LAS glasses, the values CS and DoL are also frequently specified with reference to the respective components or ions, thus for example, the compressive stress resulting from the exchange of potassium is given as “CS potassium” and the corresponding compressive stress depth is given as “potassium DoL” or potassium compressive stress depth.

The compressive stress depth, if it is specified relative to the respective exchanged components or ions, is also referred to as the so-called “exchange depth”. In the scope of the present disclosure, the terms: exchange depth, compressive stress depth and the DoL are used as synonyms.

It should be noted here, however, that the terms “potassium DoL” or “sodium DoL” are commonly used. However, the potassium DoL here involves a hypothetical value. The sodium DoL and the DoL are identical, just as potassium CS and CS are identical. For example, designated as the “potassium DoL” or “potassium exchange depth” is the value that results due to extension of the compressive stress curved obtained by the potassium exchange with the point of intersection of the X axis. Therefore, insofar as the “potassium DoL is indicated in the scope of the present disclosure, this involves the value which is determined or is to be determined, as described above, which is, however, hypothetical.

In the scope of the present disclosure, a so-called “sharp impact” is understood as a load, in which the damage is produced by a small, pointed object or by a plurality of such small, pointed objects. In other words, it thus involves an action with one or more pointed objects, thus, for example, with particles that have very small radii of curvature or in which the angle of the tip is less than 100°.

In the scope of the present disclosure, insofar as the grain size distribution or grit of an abrasive paper is indicated, this is specified in reference to, and preferably in agreement with, DIN ISO 6344. This grain size distribution or grit is oriented toward the mesh unit of measure. The larger the specified grit is, the smaller the abrasive particles are. In the scope of the present disclosure, to designate the grit, the terms “60 grit” and “#60” are used synonymously here, for example, relative to a so-called 60 grit. This applies, of course, in a corresponding manner to other grits, such as, for example, a 100 or 180 grit.

In the scope of the present disclosure, the term: field strength of an ion is used according to Dietzel. In particular, this term is used referred to an oxidic glass matrix, wherein it is understood that this value may change, each time depending on the coordination number of the ion in question.

With respect to the terms: network modifier and network former, these are understood to be according to Zachariasen.

In the scope of the present disclosure, the following are particularly designated as network formers: SiO₂, Al₂O₃, B₂O₃, P₂O₅.

Designated as network modifiers are, in particular: alkali oxides and alkaline earth oxides.

Designated as a so-called intermediate oxide, in particular, is ZrO₂.

According to one embodiment of the glass article, the glass comprises, and/or the glass article comprises, at most 3 wt. % P₂O₅, preferably at most 2 wt. % P₂O₅, and particularly preferred at most 1.7 wt. % P₂O₅.

P₂O₅ is a glass component that is network-forming and can increase the melting capacity of a glass. P₂O₅, however, can lead to difficulties in production, since the material of the molten aggregate can be attacked. Therefore, the phosphate content is preferably limited.

According to another embodiment of the glass article, the glass comprises, and/or the glass article comprises, at most 7 wt. % B₂O₃, preferably at most 5 wt. % B₂O₃, and particularly preferred, at most 4.5 wt. % B₂O₃.

B₂O₃ is also a network-forming glass component and can be advantageous, since a content of B₂O₃ in a glass lowers the melting point and thus improves the melting capacity of a glass. Of course, it has been shown that too high a content in a glass that is accessible to an ion exchange negatively affects prestressing. This is not completely understood, but could lie in the fact that a boron-containing glass network may possibly relax more easily, thus is less rigid. Therefore, according to one embodiment, the content of B₂O₃ in the glass or the glass article is limited.

In fact, a content of B₂O₃ in a glass also leads to an increase in resistance to scratching. Therefore, it had previously been assumed that a certain content of a chemically prestressed or at least prestressable glass article containing B₂O₃ should increase the stability of a glass article against sharp-impact loads. This effect appears to be limited of course, so that the content of the glass and/or of the glass article according to embodiments amounts to at most 7 wt. %, particularly preferred at most 5 wt. %, and most particularly preferred at most, 4.5 wt. %.

According to one embodiment of the glass article, the glass has, or the glass article has an E-modulus of more than 75 MPa, preferably of more than 80 MPa.

The E-modulus of a material describes its property to resist a deformation as a consequence of the action of a mechanical load. It has been shown that a good prestressability of a glass or a glass article can correlate with the E-modulus, at least partially. Thus, a glass with a higher E-modulus appears to be better prestressable or seems to show more advantageous mechanical properties in the prestressed state than a glass with a lower E-modulus. It should be noted here that the mechanical properties of a glass or of a glass article cannot be considered in an absolute sense, but are to be considered specific to the application. In the scope of the present disclosure, in particular, those properties that have been achieved with regard to loads with pointed objects, in particular, so-called sharp-impact loads are considered as advantageous mechanical properties.

It is presumed that this correlation could possibly be attributed to the fact that the E-modulus is a macroscopically measurable expression of the microscopic, i.e., could be attributed to the structural build-up of the glass present on the glass network plane. A rigid glass network, which has its cause, for example, in the overall very high content of network formers and/or in the type of network formers, in particular in the very small content of B₂O₃ in the glass and/or in the glass article, and/or in a relatively small content of alkali ions in the glass and/or the glass article, according to embodiments of the glass or glass article according to the present disclosure, could then macroscopically find its expression in a relatively high E-modulus.

It is unclear, however, which of the particularly determining factors for the formation of a rigid network this would be. One factor, which should lead, for example, to the formation of a dense network is the content of network formers, in particular of SiO₂. According to one embodiment of the glass article and/or of the glass, the glass and/or the glass article comprises 57 wt. % SiO₂, preferably at least 59 wt. % SiO₂, and particularly preferred at least 61 wt. %. It has been shown that with such minimal contents of SiO₂, advantageous mechanical stabilities of a glass article are obtained.

Even when a very high content of SiO₂, corresponding to an approximation of silica glass SiO₂ that is as high as possible with respect to the formation of a rigid network with high E-modulus, could be advantageous, the SiO₂ content of the glass or of the glass article is preferably limited, however. This is due, on the one hand, to the fact that a glass with a very high SiO₂ content no longer has a good meltability. It has also been shown that a very rigid body, such as, for example, pure silica glass, however, is also very brittle. In other words, such a body in fact has an initially intrinsically high mechanical stability, which can be expressed, for example, in a high E-modulus. However, once a load has occurred that has led to a crack formation, then in such a case, there occurs an abrupt crack propagation.

Therefore, the content of the glass and/or of the glass article, according to embodiments, should not be too high and is advantageously limited. Preferably, the glass and/or the glass article comprise(s) at most 69 wt. %, preferably at most 67 wt. % SiO₂. In this way, a good meltability is still ensured.

Another component of the glass or of the glass article is Al₂O₃. Al₂O₃ is a component that also acts as a network former and is a very hard material in pure form as crystalline Al₂O₃ (corundum). It has been shown that Al₂O₃ as a glass constituent can advantageously lead to the formation of mechanically favorable properties of a prestressed glass article. Therefore, the glass or the glass article, according to embodiments of the glass or of the glass article, comprise(s) at least 17 wt. % Al₂O₃.

It is known that the number of non-bridging oxygen atoms is reduced by the addition of Al₂O₃ to an alkali silicate glass. In fact, this addition can be advantageous for the build-up of a rigid network, but it is to be seen as critical with respect to the meltability and the chemical stability of the resulting glass or glass article. Therefore, according to embodiments of the glass or of the glass article, the percentage of Al₂O₃ in the glass or glass article is limited. According to embodiments of the glass and/or of the glass article, the glass or the glass article comprises at most 25 wt. % Al₂O₃, preferably at most 21 wt. % Al₂O₃.

It has been shown that with respect to the build-up of a glass network that is as optimally prestressable as possible in an alkali silicate glass, the components and network formers Al₂O₃ and SiO₂ are interrelated. Therefore, in principle, if the glass is accessible to an ion exchange, it must comprise alkali ions. Due to the content of alkali ions, the glass network is weakened, of course, since non-bridging oxygens arise. These can be reduced by adding Al₂O₃ as a component to the glass. According to one embodiment of the glass and/or of the glass article, the sum of the content of Al₂O₃ and SiO₂ in the glass and/or the glass article lies between at least 75 wt. % and at most 92 wt. %, preferably at most 90 wt. %. Such a minimum content of Al₂O₃ and SiO₂ in the glass and/or the glass article is advantageous, since in this way, a stable, rigid network is obtained, which provides an at least sufficient chemical stability. The content of the network formers SiO₂ and Al₂O₃ in the glass and/or in the glass article should not be too high, however, since if this were the case, the glass is no longer meltable, or no longer economically meltable, and thus amounts to at most 92 wt. %, preferably 90 wt. %, according to embodiments of the glass or of the glass article. Alternatively or additionally, preferably, the entire content of network formers in the glass or glass article is no more than 92 wt. %, and particularly preferred, no more than 90 wt. %.

In addition, it has been shown that the content of Li₂O positively influences the formation of an optimally prestressable glass or glass article, and this occurs even when Li₂O itself does not participate as a component in the ion exchange. The inventors presume that a particularly dense glass structure results due to the incorporation of lithium ions in the network of the glass, since lithium ions are small ions with greater field strength. This might be advantageous, since a particularly dense glass network should provide a smaller volume for deformation in the case of mechanical action, such as, for example, with the exchange of smaller ions for larger ones, as this is the case in ion exchange, and thus would oppose a mechanical deformation. This would result, however, in an improvement in the prestressability, since an introduced stress would be better stored in the glass network.

According to one embodiment of the glass and/or of the glass article, the glass and/or the glass article therefore comprise(s) at least 3 wt. % Li₂O, preferably at least 3.5 wt. % Li₂O.

The percentage of Li₂O should not be too high, however, and is preferably limited. As is known, when Li₂O is a component in glasses, it leads also to demixing and/or crystallization of the glass. According to embodiments of the glass and/or of the glass article, the glass and/or the glass article therefore comprise(s) at most 5.5 wt. % Li₂O.

As an alkali oxide, Na₂O is a network modifier. It is advantageous if the glass and/or the glass article comprise(s) Na₂O, since in this case, an ion exchange of sodium ions for potassium ions is possible, thus, in particular, a so-called mixed exchange. As also mentioned above, this may lead to particularly advantageous designs of a glass article with respect to the mechanical properties. According to one embodiment of the glass or of the glass article, the glass and/or the glass article comprise(s) at least 0.8 wt. % Na₂O.

Too much Na₂O is unfavorable, however. In particular, the content of Na₂O reduces the chemical stability of the glass, particularly also the acid resistance. Therefore, according to embodiments of the glass and/or the glass article, the content of Na₂O is preferably limited. Preferably, according to one embodiment, the glass or the glass article comprises at most 8 wt. % Na₂O, preferably at most 7.5 wt. % and particularly preferred, at most 7 wt. %.

The glass article should preferably have a thickness that is not too small. The thickness of the glass article also influences its mechanical stability. Therefore, according to one embodiment, the thickness of the glass article amounts to at least 0.4 mm, preferably at least 0.5 mm.

In addition, it is advantageous if the glass article does not have too great a thickness. Since in contrast, for example, to transparent plastics, the density of glass is higher, so that in the event of a fall of a glass article that is too thick, for example a mobile device that is equipped with such a glass article, the thickness is too great. The thickness of the glass article according to one embodiment therefore amounts to at most 3 mm, preferably at most 2 mm, and particularly preferred, at most 1 mm. With such a glass article, which has a thickness in the above-given limits, an optimal compromise between a good mechanical stability of the glass article and a low weight is achieved.

The present disclosure also refers to a lithium-aluminum-silicate glass and a glass article that comprises such a glass or essentially comprises it, thus at least 50 wt. %, or predominantly comprises it, thus at least 90%, or even is completely composed of this glass. The lithium-aluminum-silicate glass comprises the following components in wt. %:

| | |
|---|---|
| SiO₂ | 57 to 69, preferably 59 to 69, particularly preferred 61 to 69, |
| | wherein the upper limit in each case can preferably be 67, |
| Al₂O₃ | 17 to 25, preferably 17 to 21, |
| Li₂O | 3 to 5.5, preferably 3.5 to 5.5, |
| Na₂O | 0.8 to 8, preferably 0.8 to 7.5, particularly preferred 0.8 to 7, |

wherein, preferably, the sum of the content of Al₂O₃ and SiO₂,
referred to the data in wt. % lies between at least 75 and at most 92,
preferably at most 90.

It has been shown that such a glass, which comprises the above-named components in the above-named limits, is advantageously designed as prestressable. In particular, a small crack tip intensity can be achieved with such a glass. In addition, the glass also has a high CIL, and, in fact, is already in the non-prestressed state.

The lithium-aluminum-silicate glass is accessible to a prestressing process, in which an ion exchange is carried out in an exchange bath comprising between at least 20 wt. %, and up to 100 wt. % of a sodium salt, preferably sodium nitrate NaNO₃, for a duration of at least 2 hours, preferably at least 4 hours, and at most 24 hours at a temperature between at least 380° C. and at most 440° C., wherein optionally, a potassium salt, particularly potassium nitrate can be added to the exchange bath, in particular such that the sum of the content of sodium salt and potassium salt adds up to 100 wt. %.

as well as, optionally, a second ion exchange in an exchange bath comprising between 0 wt. % and 10 wt. % of a sodium salt, preferably sodium nitrate NaNO₃, referred to the total amount of the salt, for a duration of at least one hour and at most 6 hours at a temperature of the exchange bath of at least 380° C. and at most 440° C., wherein a potassium salt, particularly preferred potassium nitrate KNO₃ is added to the exchange bath, in particular such that the sum of the content of sodium salt and potassium salt adds up to 100 wt. %.

In addition, it is possible that still further ion exchange steps will be conducted.

The present disclosure thus also refers to a method for producing a glass article, in particular a glass article according to embodiments of the present disclosure, comprising the steps:

an ion exchange is conducted in an exchange bath comprising between at least 20 wt. %, and up to 100 wt. % of a sodium salt, preferably sodium nitrate NaNO₃, for a duration of at least 2 hours, preferably at least 4 hours, and at most 24 hours at a temperature between at least 380° C. and at most 440° C., wherein optionally, a potassium salt, particularly potassium nitrate can be added to the exchange bath, in particular such that the sum of the content of sodium salt and potassium salt adds up to 100 wt. %;

as well as, optionally, a second ion exchange in an exchange bath comprising between 0 wt. % and 10 wt. % of a sodium salt, preferably sodium nitrate NaNO₃, referred to the total amount of the salt, for a duration of at least one hour and at most 6 hours at a temperature of the exchange bath of at least 380° C. and at most 440° C., wherein a potassium salt, particularly preferred potassium nitrate KNO₃ is added to the exchange bath, in particular such that the sum of the content of sodium salt and potassium salt adds up to 100 wt. %, as well as optionally one or more further ion exchange steps.

The present disclosure also relates to a glass article that is produced or is producible in a method according to embodiments of the present disclosure, and/or that comprises a lithium-aluminum-silicate glass according to the present disclosure or is essentially or predominantly or completely composed of such a glass.

The glass article according to the present disclosure can be used as a cover panel, in particular, as a cover panel in consumer electronics, or as a protective glass, in particular as a protective glass, particularly as a protective glass for machines or as a glazing in high-speed trains, or as a safety glass, or as automobile glazing, or in diving watches, or in submarines, or as a cover panel for explosion-protected devices, in particular for those in which the use of glass is mandatory.

### EXAMPLES

An exemplary composition range of a lithium-aluminum-silicate glass according to embodiments of the present disclosure comprises the following components in wt. %:

| | |
|---|---|
| SiO₂ | 57 to 69, preferably 59 to 69, particularly preferred 61 to 69, |
| | wherein the upper limit in each case can preferably be 67, |
| Al₂O₃ | 17 to 25, preferably 17 to 21, |
| B₂O₃ | 0 to 7, preferably 0 to 5, particularly preferred 0 to 4.5, |
| Li₂O | 3 to 5.5, preferably 3.5 to 5.5, |
| Na₂O | 0.8 to 8, preferably 0.8 to 7.5, particularly preferred 0.8 to 7, |
| K₂O | 0 to 1, preferably 0 to 0.8, particularly preferred 0 to 0.7, |
| MgO | 0 to 2, preferably 0 to 1.5, particularly preferred 0 to 1, |
| CaO | 0 to 4.5, |
| SrO | 0 to 2, preferably 0 to 1.5, particularly preferred 0 to 1, |
| ZnO | 0 to 3, preferably 0 to 2, particularly preferred 0 to 1.5, |
| P₂O₅ | 0 to 3, preferably 0 to 2, particularly preferred 0 to 1.7, |
| ZrO₂ | 0 to 3, preferably 0 to 2.8, |

wherein, in addition, impurities and/or refining agents and/or coloring
constituents may be contained in amounts of up to 2 wt. %.

An exemplary composition of a glass, from which a plate-shaped glass article can be produced according to one embodiment is given by the following composition in wt. %:

| | |
|---|---|
| SiO₂ | 57 to 69, preferably 59 to 69, particularly preferred 61 to 69, |
| | wherein the upper limit in each case can preferably be 67, |
| Al₂O₃ | 17 to 25, preferably 17 to 21, |
| B₂O₃ | 0 to 7, preferably 0 to 5, particularly preferred 0 to 4.5, |
| Li₂O | 3 to 5.5, preferably 3.5 to 5.5, |
| Na₂O | 0.8 to 8, preferably 0.8 to 7.5, particularly preferred 0.8 to 7, |

wherein, preferably, the sum of the content of Al₂O₃, and SiO₂,
referred to the data in wt. % lies between at least 75 and at most 92,
preferably at most 90.

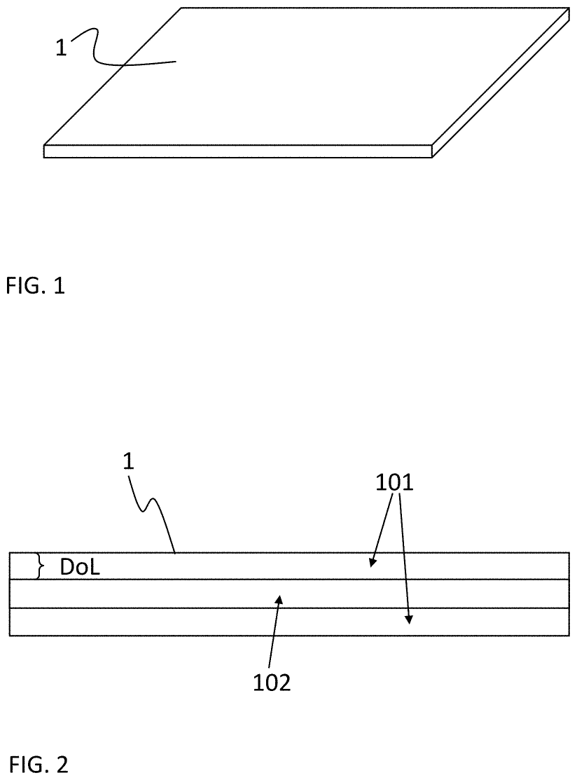

Referring now to FIG. 1, a schematic and not-true-to-scale representation of a plate-shaped glass article according to present disclosure is shown. FIG. 2 shows a schematic and not-true-to-scale sectional representation of the glass article of FIG. 1.

In this case, the glass article 1 has two zones 101 that are under compressive stress and are also designated as compressive stress zones arranged on the two main surfaces of the glass article. These compressive stress zones 101 have the dimension “DoL” also schematically depicted in FIG. 2. It is possible that the DoL is differentiated on the two sides of the plate-shaped glass article with respect to the size thereof, whereby these differences, however, usually lie in the framework of measurement precision, so that the DoL for a plate-shaped glass article 1 is usually equal on both sides—at least in terms of measurement precision.

The region 102 that is under tensile stress lies between the compressive stress zones 101.

FIG. 3 shows an overall view of the set-drop test apparatus with labeling of the individual components. FIG. 4a shows the sample mount of the set-drop test apparatus of FIG. 3. FIG. 4b shows the release mechanism of the set-drop test apparatus FIG. 3.

FIG. 5 shows the aluminum housing as the sample mount and the plastic plate as the sample dummy.

FIG. 6 shows the alignment of the sample dummy in the sample mount by means of 2D water balance.

### LIST OF REFERENCE NUMBERS

1 Plate-shaped glass article
101 Compressive stress zone
102 Inner region of the glass article standing under tensile stress

What is claimed is:

1. A plate-shaped or disc-shaped, chemically prestressed or chemically prestressable glass article, comprising:
a glass with a composition comprising SiO₂, Al₂O₃, and Li₂O; and
a set-drop strength of at least 50 and up to 150, given as drop height in cm, wherein the drop height is given as the mean value of 15 samples, with the use of a sandpaper grit of 60,
wherein the glass has at least one feature selected from a group consisting of: a CIL of greater than 1 N, a CIL of greater than 1.2 N, a CIL of greater than 2 N, a CIL of greater than 3 N, a DoL of at least 90 μm for a thicknesses of the glass article of at least 0.4 mm up to at most 0.55 mm, a DoL of at least 100 μm for a thicknesses of the glass article of at least 0.4 mm up to at most 0.55 mm, a DoL of at least 115 μm for a thicknesses of the glass article of more than 0.55 mm up to at most 0.7 mm, a DoL of at least 130 μm for a thicknesses of the glass article of more than 0.7 mm up to at most 1 mm, a DoL of at least 130 μm for a thicknesses of the glass article of more than 1 mm and up to 3 mm, a content of network formers of at least 82 wt. %, a content of alkali oxides of at most 14 wt. %, a content of alkali oxides of at most 12 wt. %, and any combinations thereof.

2. The glass article of claim 1, wherein the CIL is determined in a non-prestressed state.

3. The glass article of claim 1, wherein the composition comprises at most 3 wt. % P₂O₅.

4. The glass article of claim 1, wherein the composition comprises at most 1.7 wt. % P₂O₅.

5. The glass article of claim 1, wherein the composition comprises at most 7 wt. % B₂O₃.

6. The glass article of claim 1, wherein the composition comprises at most 4.5 wt. % B₂O₃.

7. The glass article of claim 1, further comprising an E-modulus of more than 75 MPa.

8. The glass article of claim 1, wherein the composition comprises at least 57 wt. % SiO and at most 69 wt. % SiO₂.

9. The glass article of claim 1, wherein the composition comprises at least 17 wt. % Al₂O₃ and at most 25 wt. % Al₂O₃.

10. The glass article of claim 1, wherein the composition comprises a sum of a content of Al₂O₃ and SiO₂ between at least 75 wt. % and at most 92 wt. %.

11. The glass article of claim 1, wherein the composition comprises an entire content of network formers of no more than 92 wt. %.

12. The glass article of claim 1, wherein the composition comprises at least 3 wt. % Li₂O and at most 5 wt. % Li₂O.

13. The glass article of claim 1, wherein the composition comprises at least 0.8 wt. % Na₂O and at most 8 wt. % Na₂O.

14. The glass article of claim 1, further comprising a thickness of at least 0.4 mm.

15. The glass article of claim 1, further comprising a thickness of at most 3 mm.

16. The glass article of claim 1, wherein the glass article is configured for a use selected from a group consisting of a cover panel, a cover panel for a consumer electronic device, a cover panel for a display device, a cover panel for a computer monitor, a cover panel for a measurement device, a cover panel for a television, a cover panel for a mobile device, a cover panel for a mobile terminal, a cover panel for a mobile data processing device, a cover panel for a mobile phone, a cover panel for a mobile computer, a cover panel for a palm top, a cover panel for a laptop, a cover panel for a tablet computer, a cover panel for a wearable device, a cover panel for a portable watch, a cover panel for a time measuring device, a protective glass for a machine, a glazing for a high-speed train, safety glass, an automobile glazing, a diving watch, a submarine, and a cover panel for an explosion-protected device.

17. A lithium-aluminum-silicate glass, comprising a composition, in wt. %, of:

| | |
|---|---|
| SiO₂ | 57 to 69, |
| Al₂O₃ | 17 to 25, |
| Li₂O | 3 to 5.5, |
| Na₂O | 0.8 to 8, and |

a sum of a content of Al₂O₃ and SiO₂ lies between at least
75 and at most 92.

18. The lithium-aluminum-silicate glass of claim 17, wherein the composition comprises:

| | |
|---|---|
| SiO₂ | 61 to 69, |
| Al₂O₃ | 17 to 21, |
| Li₂O | 3.5 to 5.5, and |
| Na₂O | 0.8 to 7.5. |

19. A method for producing a glass article, comprising:
providing a lithium-aluminum-silicate glass, comprising a composition, in wt. %, of: SiO₂ 57 to 69, Al₂O₃ 17 to 25, Li₂O 3 to 5.5, Na₂O 0.8 to 8, and a sum of a content of Al₂O₃ and SiO₂ lies between at least 75 and at most 92; and
conducting a first ion exchange between the glass and a first exchange bath comprising between at least 20 wt. % and up to 100 wt. % of sodium nitrate for a duration of at least 2 hours and at most 24 hours at a temperature of the first exchange bath of between at least 380° C. and at most 440° C.

20. The method of claim 19, wherein the first exchange bath further comprises potassium nitrate such that a sum of the content of sodium and potassium nitrate add up to 100 wt. %.

21. The method of claim 19, further comprising conducting a second ion exchange in a second exchange bath comprising between 0 wt. % and 10 wt. % of sodium nitrate for a duration of at least one hour and at most 6 hours at a temperature of the second exchange bath of at least 380° C. and at most 440° C.

22. The method of claim 21, further comprising adding the sodium nitrate to the first exchange bath to provide the second exchange bath.
